(19) United States
(12) Patent Application Publication
(10) Pub. No.: US 2025/0267092 A1
(43) Pub. Date: Aug. 21, 2025

(54) RELIABLE MULTICAST TRAFFIC IN MULTI-PATH HIGH-PERFORMANCE COMPUTING NETWORKS

(71) Applicant: Samsung Electronics Co., Ltd., Suwon-si (KR)

(72) Inventors: Bruce Gregory WARREN, Poulsbo, WA (US); Rohit BHATIA, Fort Collins, CO (US); Eric Richard BORCH, Fort Collins, CO (US)

(21) Appl. No.: 18/789,655

(22) Filed: Jul. 30, 2024

Related U.S. Application Data
(60) Provisional application No. 63/554,930, filed on Feb. 16, 2024.

(51) Int. Cl. H04L 45/16; H04L 1/08; H04L 45/7453

(52) U.S. Cl. CPC H04L 45/16; H04L 1/08; H04L 45/7453

(57) ABSTRACT

Provided are systems, methods, and apparatuses for efficient propagation of multicast traffic in multi-path HPC networks. In one or more examples, the systems, devices, and methods include receiving, from a first switch at a second switch, an encapsulated packet comprising information that includes a route to the second switch; obtaining a source packet from the encapsulated packet based on de-encapsulating the encapsulated packet; and transmitting a first copy of the source packet to a first node of the second switch based on copying the source packet. The systems, methods, and apparatuses include distributing multicast traffic to intended participants with the minimal number of replicated packets. Some examples of the systems, methods and apparatuses provide reliable delivery via support for non-posted packets, collating completion responses from participants into a single completion to the multicast packet originator.

### CROSS-REFERENCE TO RELATED APPLICATIONS

This application claims the benefit of U.S. Provisional Patent Application Ser. No. 63/554,930, filed Feb. 16, 2024, which is incorporated by reference herein for all purposes.

### TECHNICAL FIELD

The disclosure relates generally to computer networks, and more particularly to propagation of multicast traffic in multi-path high-performance computing networks.

### BACKGROUND

The present background section is intended to provide context only, and the disclosure of any concept in this section does not constitute an admission that said concept is prior art.

Computer networking is the process of connecting computing devices so they can share resources and exchange data. These devices can be connected using physical wires, like fiber optics, or wirelessly. To transmit information, networked devices may use a set of rules called communication protocols over these technologies. Multicast is a type of group communication in computer networking that allows data to be sent to multiple destinations simultaneously. Multicast can be one-to-many or many-to-many distribution.

### SUMMARY

In various embodiments, the systems and methods described herein include systems, methods, and apparatuses for reliable propagation of multicast traffic in multi-path HPC networks. In some aspects, the systems and methods described herein relate to . . . .

In some aspects, the techniques described herein relate to a method of a computer network, the method including: receiving, from a first switch at a second switch, an encapsulated packet including information that includes a route to the second switch; obtaining a source packet from the encapsulated packet based on de-encapsulating the encapsulated packet; and transmitting a first copy of the source packet to a first node of the second switch based on copying the source packet.

In some aspects, the techniques described herein relate to a method, further including transmitting a second copy of the source packet to a second node of the second switch based on copying the source packet. In some aspects, the techniques described herein relate to a method, further including: receiving, from the first node, a first node acknowledgement indicating the first node received the first copy of the source packet; and receiving, from the second node, a second node acknowledgement indicating the first node received the first copy of the source packet.

In some aspects, the techniques described herein relate to a method, further including transmitting, to the first switch, a switch acknowledgement indicating the second switch received the encapsulated packet. In some aspects, the techniques described herein relate to a method, wherein the switch acknowledgement indicates the first node of the second switch received the first copy of the source packet and indicates the second node of the second switch received the second copy of the source packet.

In some aspects, the techniques described herein relate to a method, further including omitting transmission of a copy of the source packet to a third node of the second switch based on the information excluding the third node. In some aspects, the techniques described herein relate to a method, further including: generating a hash based on receiving a second encapsulated packet; comparing the hash to a group hash associated with a multicast group that includes the first switch and the second switch; and dropping the second encapsulated packet based on the comparing indicating a match between the hash and the group hash.

In some aspects, the techniques described herein relate to a method, wherein: the encapsulated packet includes the source packet that is encapsulated by the first switch, and a header of the encapsulated packet includes the information for one or more switches, including the second switch. In some aspects, the techniques described herein relate to a method, wherein de-encapsulating the encapsulated packet includes removing the information from the encapsulated packet.

In some aspects, the techniques described herein relate to a method, wherein: the computer network includes a high-performance computing (HPC) network protocol based on at least one of peripheral component interconnect express (PCIe), InfiniBand, Ethernet or Omni-Path, and the source packet includes a format based on the HPC network protocol.

In some aspects, the techniques described herein relate to a method of a computer network, the method including: obtaining, at a first switch, a source packet from a source node of the first switch; generating an encapsulated packet based on information that includes a route to a second switch; transmitting a first copy of the encapsulated packet to the second switch; and receiving, from the second switch, a switch acknowledgement indicating the second switch received the encapsulated packet.

In some aspects, the techniques described herein relate to a method, further including: identifying a failed link to a third switch; and routing a second copy of the encapsulated packet to the third switch over an alternative path based on network topology information of the computer network. In some aspects, the techniques described herein relate to a method, wherein generating the encapsulated packet includes adding the information to a header of the encapsulated packet.

In some aspects, the techniques described herein relate to a method, wherein the switch acknowledgement indicates a first node of the second switch received a first copy of the source packet and a second node of the second switch received a second copy of the source packet. In some aspects, the techniques described herein relate to a method, wherein: the computer network includes a high-performance computing (HPC) network protocol based on at least one of peripheral component interconnect express (PCIe), InfiniBand, Ethernet or Omni-Path, and the source packet includes a format based on the HPC network protocol.

In some aspects, the techniques described herein relate to a non-transitory computer-readable medium storing code that includes instructions executable by a processor of a second switch to: receive, from a first switch at the second switch, an encapsulated packet including information that includes a route to the second switch; obtain a source packet from the encapsulated packet based on de-encapsulating the encapsulated packet; and transmit a first copy of the source packet to a first node of the second switch based on copying the source packet.

In some aspects, the techniques described herein relate to a non-transitory computer-readable medium, wherein the code includes further instructions executable by the processor to cause the second switch to transmit a second copy of the source packet to a second node of the second switch based on copying the source packet.

In some aspects, the techniques described herein relate to a non-transitory computer-readable medium, wherein the code includes further instructions executable by the processor to cause the second switch to: receive, from the first node, a first node acknowledgement indicating the first node received the first copy of the source packet; and receive, from the second node, a second node acknowledgement indicating the first node received the first copy of the source packet.

In some aspects, the techniques described herein relate to a non-transitory computer-readable medium, wherein the code includes further instructions executable by the processor to cause the second switch to transmit, to the first switch, a switch acknowledgement indicating the second switch received the encapsulated packet.

In some aspects, the techniques described herein relate to a non-transitory computer-readable medium, wherein the switch acknowledgement indicates the first node of the second switch received the first copy of the source packet and indicates the second node of the second switch received the second copy of the source packet.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The techniques of reliable propagation of multicast traffic in multi-path HPC networks described herein include multiple advantages and benefits. For example, the described techniques dramatically reduce the number of packets generated for multicast operations. Instead of the potential squared term explosion of packets created, the minimum number of packets for a given multicast distribution group are produced. Also, the described techniques enable routing around failed links to distribute multicast packets (e.g., based on routing information in encapsulated packets and route tables providing alternative paths). Also, the described techniques enable quick scrub duplicate multicast packets of a network based on a hash check or similar mechanism. Also, the described techniques provide a completion mechanism for system robustness. Also, the described techniques minimize traffic (e.g., avoid flooding) by preventing packets from being blindly duplicated and forwarded. Also, the described techniques relieve the sender from knowing every intended destination and generating a unique frame addressed to each destination. Furthermore, the described techniques prevent a multicast packet from degenerating into a series of unicast targeted to the intended endpoints specified in the associated multicast group at the first switch.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates an example packet format in accordance with one or more implementations as described herein.

FIG. 5 illustrates an example diagram in accordance with one or more implementations as described herein.

FIG. 6 illustrates an example diagram in accordance with one or more implementations as described herein.

FIG. 7 depicts a flow diagram illustrating an example method associated with the disclosed systems, in accordance with example implementations described herein.

FIG. 8 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some example embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., DSPs) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, system-on-a-chip, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

Random access memory (RAM) is short-term memory, where the processor stores data that is used to run an operating system, applications, open files, etc. Dynamic RAM (DRAM) is a temporary memory bank that stores data for quick access. DRAM may be used in personal computers, workstations, servers, etc. DRAM is volatile memory, meaning it loses stored data when the power is removed. DRAM stores data in a charge on a transistor and capacitor pair. Each bit of data is stored in a memory cell, which may include a capacitor and a transistor.

Double data rate (DDR) is a computing technique that allows a computer bus to transfer data at double rate on both rising and falling edges of a clock cycle or signal. DDR enables the sending of two signals per clock cycle. DDR Synchronous DRAM (DDR SDRAM) is a type of memory technology that improves performance in computing devices. DDR SDRAM is a random-access memory module that offers faster performance and higher transfer rates than older RAM modules. Low power DDR (LPDDR) is a type of DRAM that uses less energy and has more power-saving capabilities than previous generations of RAM. A DDR memory system may include a DDR memory controller and a DDR PHY to access DDR memory. The DDR PHY Interface (DFI) is an interface protocol that defines signals, timing, and programmable parameters used to transfer control information and/or data between a DRAM device (e.g., DDR memory controller logic, a DDR microcontroller) and a PHY (e.g., DDR PHY interface). DFI is applicable to all DRAM protocols including DDR4, DDR3, DDR2, DDR, LPDDR4, LPDDR3, LPDDR2 and LPDDR.

High performance computing (HPC) is the practice of combining computing resources to achieve better performance than a single computer, server, or workstation. HPC can be implemented as supercomputers or clusters of individual computers. HPC is used to solve large problems in business, engineering, and science by processing data and performing calculations at a faster rate than personal computers. For example, a laptop or desktop with a 3 GHz processor can perform around 3 billion calculations per second, while HPC can perform quadrillions of calculations per second. HPC can use the latest central processing units (CPUs), graphics processing units (GPUs), high-bandwidth memory (HBM), computational storage, near-memory processing (NMP), clusters of systems on chip (SoCs), and low-latency networking fabrics to perform large calculations in a fraction of the time it would take single computers. HPC can use GPU-accelerated systems for computationally intensive simulations that use large amounts of data and parallel computing.

HPC networking is a network infrastructure that supports low latency, high bandwidth, and multiple concurrent connections (e.g., between computing resources of a given HPC system). HPC networking is based on data networks between components of a cluster of HPC compute resources. HPC networking can use hundreds or thousands of compute servers that are networked to form a cluster. Algorithms and software programs run concurrently on the servers in the cluster. HPC clusters include groups of multiple servers that process complex calculations simultaneously in parallel. Each component computer in an HPC cluster may be referred to as a node. An HPC cluster can be networked with data storage. The HPC modules can be configured to work together to complete different tasks. HPC technologies can use a collapsed network backbone to make clusters and grids easier to troubleshoot. HPC systems can use an Ethernet fabric based on network interface cards and switches with sophisticated congestion control to ensure consistent bandwidth and latency between resources.

High bandwidth memory (HBM) is a type of computer memory technology that integrates system memory into the processor package. HBM is designed to provide low power consumption and high-bandwidth. HBM may use a 3D stacking technology that connects vertically stacked memory chips with microscopic wires called through-silicon vias (TSVs). An HBM stack can contain up to eight DRAM modules, which are connected by two channels per module. HBM offers a higher memory rate than DDR5 memory, making it ideal for applications that need extreme data bandwidth. HBM may be used in high-performance computing applications, such as network devices, high-performance datacenters, AI ASICs, and high-performance graphics accelerators.

Computational storage is a storage device architecture that allows data to be processed at the storage device level. Computational storage adds compute resources (e.g., processing units) to storage devices. Computational storage is also known as in-situ processing or in-storage compute. Computational storage devices have processors that can execute specific computational functions directly within the storage hardware. This allows for the ability to perform selected computing tasks within or adjacent to a storage device, rather than the central processor of a server or computer. Thus, computational storage reduces the amount of data that needs to move between the storage plane and the compute plane. Computational storage adds compute to storage in ways that drive efficiencies and enable enhanced complementary functions. Computational storage architectures improve application performance and infrastructure efficiency.

Near-memory processing (NMP) is a paradigm that allows memory-centric computing. It involves moving compute capability next to the main memory (DRAM modules). This can help address the CPU-memory bandwidth bottleneck and improve the performance of memory-constrained workloads. In some cases, NMP may include cache memory in a CPU chip or to memory inside a CPU package.

A system-on-chip (SoC) is a microchip that contains all the necessary electronic circuits and parts for a given system. An SoC is a type of integrated circuit (IC) design that combines many or all high-level function elements of an electronic device onto a single chip. This differs from traditional electronics design, which uses separate components mounted to a motherboard. SoCs typically contain a processor, memory, input/output interfaces, etc. SoCs may include analog, digital, mixed signal and other radio frequency functions all lying on a single chip substrate. SoCs are used in electronics industry due to low power consumption. SoCs are used in for mobile phones, routers, digital cameras, etc.

Solid-state drives (SSDs) are storage devices used in computers that stores data on solid-state flash memory (e.g., NAND flash memory). NAND flash is a non-volatile storage technology that stores data without requiring power. NAND flash may be referred to as a memory chip. Flash memory cards and SSDs use multiple NAND flash memory chips to store data. In data management, “hot” data is data that is frequently accessed or in high demand. Hot data is regularly in demand and in transit, and is not stored for long periods of time. Thus, data hotness is the relative degree of how often data is accessed or requested. SSDs work with a computer's memory (random-access memory (RAM)) and processor to access and use data. This includes files like operating systems, programs, documents, games, images, media, etc. SSDs are permanent or non-volatile storage devices, meaning SSDs maintain stored data even when power to the computer is off. SSDs may be used as secondary storage in a computer's storage hierarchy.

The HPC networking systems and methods described herein may be based on Ethernet networking architectures. In some examples, HPC systems (e.g., HPC networking) may include non-volatile memory express (NVMe). NVMe is a data transfer protocol for SSDs and flash storage. NVMe was created to improve speed and performance of computer systems. NVMe is designed to use the PCI Express (PCIe) bus to connect SSD storage to servers and/or processors (e.g., central processing units).

In some examples, one or more aspects of HPC systems (e.g., HPC networking) may be based on peripheral component interconnect express (PCIe). PCIe is a high-speed interface standard that allows for the connection of various internal components in a computer system. PCIe is commonly found in desktop and mobile computers, server systems, set-top boxes, and gaming consoles. PCIe is used for connecting expansion cards (graphics cards, network cards, storage controllers) to a motherboard. In its simplest form, PCIe is a point-to-point connection between two PCIe compatible devices (e.g., between a motherboard and an expansion card or storage device, etc.). PCIe may be used to connect high-speed input output (HSIO) components such as graphics cards, SSDs, capture cards, wireless cards, redundant array of independent disks (RAID) cards, WiFi cards, etc. Compute express link (CXL) is an open standard for high-speed communication between a central processing unit (CPU) and other devices. CXL is built on the PCIe physical and electrical interface.

In some examples, one or more aspects of HPC systems (e.g., HPC networking) may be based on InfiniBand, Omni-Path, Slingshot, and/or Ultra Ethernet. InfiniBand can include a channel-based fabric that facilitates high-speed communications between interconnected nodes. An InfiniBand network may be made up of processor nodes, such as PCs, servers, storage appliances and peripheral devices. InfiniBand networks can include network switches, routers, cables, connectors, etc. Omni-Path may be based on Omni-Path Architecture (OPA), which may include a high-performance communication architecture. Slinghshot may be based on Slingshot Interconnect, which may include a high-performance network for HPC supercomputers and HPC clusters. Ultra Ethernet may include an Ethernet-based communication stack architecture for high-performance networking. Thus, Ethernet networking architectures described herein may be based on at least one of NVME, PCIe, InfiniBand, Omni-Path, Slingshot, and/or Ultra Ethernet.

Multicast is a computer networking method that allows a single source to communicate with multiple receivers simultaneously. It can be a one-to-many or many-to-many distribution. With multicast, a source sends a single copy of data to a single multicast address. The multicast server sends out a single stream during transmission. The broadcast packets are forwarded from the multicast server source to a client subnet where multiple client devices are listening for packets. Multicast can use user datagram protocol (UDP) to broadcast a stream over a closed internet protocol (IP) network like a local area network (LAN) or an IP service provider's network. Multicast IP routing protocols are used to distribute data to multiple recipients, such as audio/video streaming broadcasts. Multicast may be used in distributed multimedia applications. For example, multiparty audio/video conferencing is a widely used services in Internet telephony.

A packet engine, or packet processing engine (PPE), is a system that includes software and/or hardware resources. The packet processing logic of a packet engine includes hardware and/or software mechanisms that take action based on the results of evaluating different fields of incoming packets. Packet processing can integrate Ethernet interfaces, crypto-engines, pattern matching engines, and/or hardware queues for quality of service (QOS). A packet engine may include a packet analyzer, or packet sniffer, that is configured to intercept and monitor packets as they traverse a network. A packet engine may include a network analyzer, protocol analyzer, and/or packet capture appliance. A packet engine may include a fast-forwarding engine (FFE), a packet processing architecture that helps optimize the packet-routing process. FFE classifies packets into packet flows based on the IP protocol, source and destination IP address, and protocol-specific information.

In data networks, flooding is a way to quickly distribute data (e.g., critical data, updates, etc.) to each node in a given system (e.g., each node in an HPC system). Flooding may be based on multicast. Flooding may be based on an algorithm that works by having each router on the path send a packet received from one neighbor to all other neighbors Similarly, a multicast storm is an excessive amount of multicast traffic that floods a network. A broadcast storm is an excessive amount of broadcast traffic that floods a network. Similar to broadcast storms, a multicast storm occurs when application participants request retransmits of information that the application participants have missed in the multicast stream.

For some topologies, flooding may not be beneficial when the topology does not include multiple paths. However, some topologies may include multipath topologies that allow for flooding and/or multicast networking methods. Flooding generates copies of the multicast frame that are sent down every link or path. In a multipath topology, this can result in excessive traffic as frames are blindly duplicated and forwarded. Based on some approaches, explicit multicast burdens the sender with having to know every intended destination and generating a unique frame addressed to each destination. Further, in some network fabrics, a multicast packet can simply degenerate into a series of unicast packets targeted to the intended endpoints specified in the associated multicast group at the first switch. The behavior of multicast packets/frames in some networks is for the receiving switches to “flood” the network with copies of the original packet to ensure propagation through the network. Problems with flooding include bandwidth consumption of the fabric with redundant traffic. Excessive resource consumption, storms, may render the fabric unable to move normal traffic, resulting in a performance bottleneck that increases communication latency and decreases system efficiency.

In some examples, when a packet travels through a protocol stack (e.g., PCIe protocol stack, TCP/IP protocol stack) of a computer network, a protocol at a given layer may add and/or remove a field from a header of the packet. When a protocol on a sending host adds data to the packet (e.g., to the packet header), this process may be referred to as data encapsulation, while removing data from the packet (e.g., from the packet header) may be referred to as de-encapsulation, unwrapping, or decapsulation. In some cases, de-encapsulation may include removing headers or trailers from a data packet to reveal the actual data (e.g., data payload) of the packet.

In some cases, the systems and methods include a transaction layer packet (TLP), where a TLP may include a packet that facilitates data transfer between PCIe devices via requests and completions. TLPs can be part of the PCI Express architecture's transaction layer, which may be the topmost layer and which may act as an intermediary between an external device's core logic and the PCIe's data link layer (DLL). TLPs can include a header, an optional data payload, and an optional TLP digest. The header may include transaction identifying information, such as the transaction type, payload length, target address, etc. The length of the header can be either 3 or 4 double words (DWords), depending on the transaction type, where a DWord may include a 32-bit unsigned integer that can range from 0 to 4294967295 in decimal. The size of the TLP overall may be based on packet type and the data the TLP carries.

The techniques described herein provide for a first switch to receive a multicast packet (e.g., from a source node). The first switch may encapsulate the original packet (e.g., add information to a header of the original packet, original broadcast/multicast packet). In some cases, the first switch may add routing information to the header of the original packet (e.g., routing information of other switches in the multicast group). In some cases, the routing information may include participant information, or information of switches that are participants or selected recipients of the source packet. The first switch may generate copies of the encapsulated packet and route the copies of the packet to the switches in the multicast group. In some examples, routing logic may be used to route inter-switch packets (e.g., copies of the encapsulated packet). For example, routing logic may be used to route packets around failed links. In some implementations, a fabric manager may be configured to provide knowledge of the topology of the fabric. The first switch may use this knowledge to encapsulate the original packet (e.g., to add routing information to the header of the original packet).

In some cases, a second switch (e.g., each switch in the multicast group that receives a copy of the encapsulated packet) may be configured to forward a copy of the original packet to endpoints associated with the second switch. For example, each switch that receives the encapsulated packet may forward a copy of the original packet (e.g., without the encapsulation information) to each endpoint associated with the respective switches. In some cases, a switch (e.g., each switch) may include a packet engine.

In HPC networks or other networks with a fabric manager, the topology of the network may be known. In some examples, the fabric manager knows which devices are connected to which switches. In some cases, the fabric manager knows which links are inter-switch links (ISLs) and which are links to end devices (compute, storage, etc.).

Based on the described techniques, instead of flooding a network with traffic in an attempt to propagate a packet throughout a system (e.g., to avoid flooding a network), a first switch receives a multicast/broadcast frame and routes the frame to a packet engine unit within the switch. In some examples, the packet engine has been configured by the fabric manager with the address of every switch in the network. Upon receipt of the multicast packet, the packet engine may be configured to create a group of addressed packets, one packet for each switch in the multicast group. Each of these packets may include the original multicast packet. The packet engine (e.g., of the originating switch) then routes the addressed packets to the other switches in the network. Upon receipt of the encapsulated multicast packet, packet engines in each of the other switches de-encapsulate the packet and forward it to appropriate end devices locally attached to that switch. In some examples, after transmission of the encapsulated packets, the originating switch may forward the multicast packet to end devices attached to the originating switch.

In some examples, a first switch may receive a source packet from a source node of the first switch, encapsulate the source packet, and distribute copies of the encapsulated packet to a first subset of participating switches, while distributing copies of the source packet to participating local nodes of the first switch, if any. The first subset of participating switches may send copies of the encapsulated packets to a second subset of participating switches, while distributing copies of the source packet to respective participating local nodes of the first subset of switches, if any. Such a hierarchal distribution decreases distribution latency by avoiding/minimizing a single-threaded distribution to other switches from the first switch. Assuming eight racks, if the first switch were to distribute copies of the encapsulated packet to a single switch per remote rack and that single switch per remote rack were to propagate to all participating switches in a respective rack, the messages would be distributed around 8× faster and reduce ISL traffic between racks based on the systems and methods described herein.

The described techniques dramatically reduce the number of packets generated for multicast operations. Instead of the potential squared term explosion of packets created, the minimum number of packets for a given multicast are produced. For example, the described techniques result in N−1 inter-switch encapsulated packets and Y−1 packets to end devices, where N is the number of participating switches in the multicast group, and Y is the number of end devices participating in the multicast operation.

In some examples, the described techniques may implement a hash and/or other mechanism such as a timeout check to handle unexpected duplicated packets. In some cases, the unexpected duplicated packets may be routed to the packet engine where they are silently discarded.

The routing tables may be configured at start-up with the base address for multicast messages as well as which engine supports each multicast group. Additionally, or alternatively, programming can be done at any time (e.g., as different applications start and/or finish). Any multicast message received from a device port may be routed to an internal multicast engine. Typically, the PCIe TLP multicast base address may be 0xff in the upper 8 address/ID bits and the multicast group is the next 5 bits (or 6 bits if bits are expanded).

When a multicast TLP is received by a switch, the packet or TLP may be routed to the appropriate packet engine for that TLP's subgroup. Validation checks of the received packet are performed (e.g., including a hash check describe in the next section.) If the validation checks pass, the local packet engine may create multiple encapsulated replicants of the original multicast message. Each replicant may have the destination address of another switch. The replicants may be sent to every other switch. The local packet engine may then forward the multicast TLP to all device ports, except the originator, enabled for that multicast group. In some cases, a local packet engine may forward a packet (e.g., multicast TLP) to any device port that is part of the multicast group.

Upon receipt of an encapsulated multicast message from another switch, the encapsulated message may be routed to the assigned (e.g., based on multicast group) packet engine for processing. The received message may be unencapsulated and its multicast group may be compared to each local end device port's credentials. Each device port, whose credentials match the received message, may be forwarded the original multicast message. In some examples, the systems and methods may include a multicast routing table, and a packet engine may use a multicast ID to look up which ports to send a packet to.

In one or more examples, multicast messages may be distributed between switches using routed and/or encapsulated replicants of the original message. Accordingly, duplicate messages may not be delivered to any device. For this case and other errant behavior and/or interoperability purposes, a given packet engine may monitor for and ensure that an end device does not re-inject a recently received multicast message.

The described techniques include one or more mechanisms for reliability and robustness, such as the ability to route around failed links to distribute multicast packets, the ability to quickly scrub duplicate multicast packets from network via hash check for system robustness. The systems and methods provide encapsulation for distribution of packets (e.g., multicast packets). The systems and methods provide a mechanism for reliable delivery of multicast packets (e.g., providing the capability of non-posted multicast packets). For example, the systems and methods provide delivery confirmation or completion responses that are sent back to a sender of a multicast packet.

The systems and methods may include a source node (e.g., packet originator) sending a source packet (e.g., multicast packet) to a local switch. The local switch may route the source packet to its packet engine. The packet engine of the local switch may generate multiple encapsulated copies of the source packet, addressing the encapsulated copies of the source packet to the respective packet engines of remote switches in the network (e.g., multicast group). In some cases, the packet engine of the local switch may forward a copy of the source packet to a node of the local switch (e.g., to each participating node of the local switch other than the source node). For example, the packet engine may transmit a first copy to a first node of the local switch, a second copy to a second node of the local switch, and so on. Upon receiving a copy of the encapsulated packet, the packet engine of a remote switch may forward a copy of the source packet (e.g., based on de-encapsulating the encapsulated packet) to one or more nodes of the remote switch (e.g., to participants locally attached to the remote switch). The systems and methods described herein ensure a minimal number of packets are created in the system and the encapsulated packets are routed to each switch for further distribution (e.g., as long as a valid path exists).

In some examples, a hash of each received multicast packet (e.g., TLP) may be generated by a packet engine and in some cases stored in a memory and/or storage device. Subsequent receipt of multicast packets may be compared to stored hash results. When a match occurs, the received multicast message may be discarded to avoid storms. When no match occurs, the hash may be stored for future comparison and the multicast packet may be forwarded. A programmable timeout may be implemented to age out hash results. In some cases, multiple sets of hashed packets may be stored at any given time per multicast group based on an amount of allocated storage.

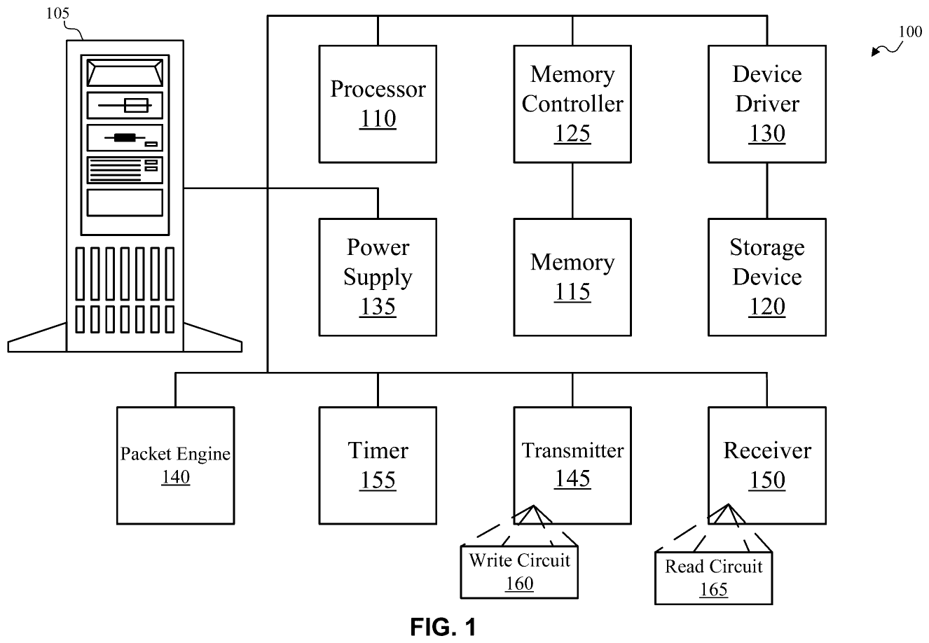

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, from memory 115 and/or storage device 120. In the illustrated example, machine 105 may include timer 155. Timer 155 may be used to track an age of a packet, to add a timestamp to a packet, to determine when a lifespan of a packet expires, etc.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, packet engine 140 functionality, and/or the like, may be implemented with hardware, software, firmware, or any combination thereof including, for example, hardware and/or software combinational logic, sequential logic, timers, counters, registers, state machines, volatile memories such as at least one of or any combination of the following: dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), GPUs, NPUs, TPUs, OPUs, and/or the like, executing instructions stored in any type of memory. In some embodiments, one or more components of packet engine 140 may be implemented as an SoC.

In some examples, packet engine 140 may include any one or combination of logic (e.g., logical circuit), hardware (e.g., processing unit, memory, storage), software, firmware, and the like. In some cases, packet engine 140 may perform one or more functions in conjunction with processor 110. In some cases, at least a portion of packet engine 140 may be implemented in or by processor 110 and/or memory 115. The one or more logic circuits of packet engine 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable packet engine 140 to provide reliable propagation of multicast traffic in multi-path HPC networks.

The systems and methods provide encapsulation for distribution of packets (e.g., multicast packets). The systems and methods provide a mechanism for reliable delivery of multicast packets (e.g., providing the capability of non-posted multicast packets). For example, the systems and methods provide delivery confirmation or completion responses that are sent back to a sender of a multicast packet.

In one or more examples, packet engine 140 may be implemented in a source switch where a source packet originates. For example, packet engine 140 may obtain a source packet from a source node, generate an encapsulated packet based on routing information that includes a route to one or more remote switches, and transmit a copy of the encapsulated packet to at least one remote switch. In some cases, packet engine 140 may receive a switch acknowledgement indicating the at least one remote switch received the copy of the encapsulated packet.

Additionally, or alternatively, packet engine 140 may be implemented in a receiving switch where an encapsulated packet of the source packet is received. For example, the packet engine 140 may receive an encapsulated packet comprising routing information that includes a route to a switch of the packet engine 140. The packet engine 140 may obtain a source packet from the encapsulated packet based on de-encapsulating the encapsulated packet. The packet engine 140 may transmit a first copy of the source packet to a first node of the receiving switch based on copying the source packet.

The techniques of reliable propagation of multicast traffic in multi-path HPC networks described herein (e.g., implemented in conjunction with packet engine 140) include multiple advantages and benefits. For example, the systems and methods reduce the number of packets injected into a given network. Because the encapsulated packet is routable, the systems and methods are resilient (e.g., based on the route tables providing multiple paths or sufficient paths). Also, the systems and methods increase reliability. For example, a remote switch may receive an encapsulated packet and transmit a source packet of the encapsulated packet to one or more nodes of the remote switch. Each node of the remote switch that receives the source packet may transmit a completion message to the remote switch. The remote switch (e.g., each remote switch receiving the encapsulated packet) may reply back to the source switch with a completion message (e.g., acknowledgment) indicating that the source packet has been received by the intended recipients (e.g., nodes of the remote switch included in the routing information). When the source switch receives a completion message from each remote switch that received a copy of the encapsulated packet, the source switch may provide a completion message to the source node that generated the original source packet.

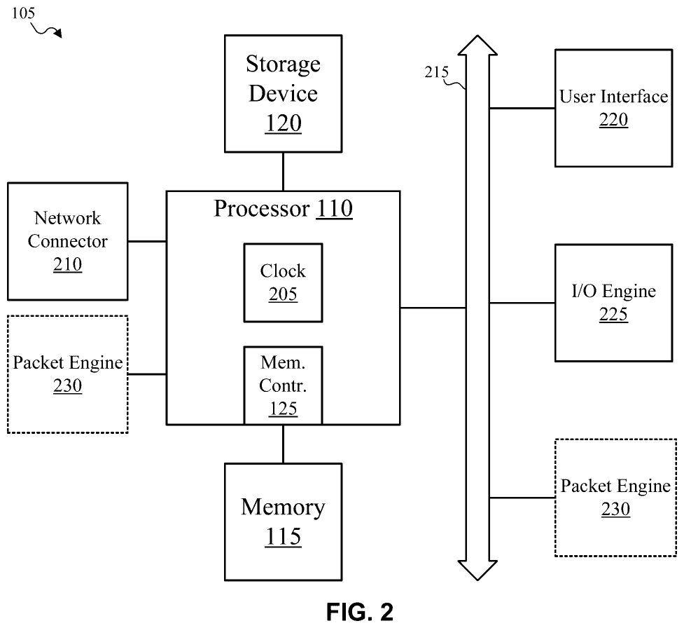

FIG. 2 illustrates details of machine 105 of FIG. 1, according to examples described herein. In the illustrated example, machine 105 may include one or more processors 110, which may include memory controllers 125 and clocks 205, which may be used to coordinate the operations of the components of the machine. Processors 110 may be coupled to memories 115, which may include random access memory (RAM), read-only memory (ROM), or other state preserving media, as examples. Processors 110 may be coupled to storage devices 120, and to network connector 210, which may be, for example, an Ethernet connector or a wireless connector. Processors 110 may be connected to buses 215, to which may be attached user interfaces 220 and Input/Output (I/O) interface ports that may be managed using I/O engines 225, among other components. As shown, processors 110 may be coupled to packet engine 230, which may be an example of packet engine 140 of FIG. 1. Additionally, or alternatively, processors 110 may be connected to buses 215, to which may be attached packet engine 230.

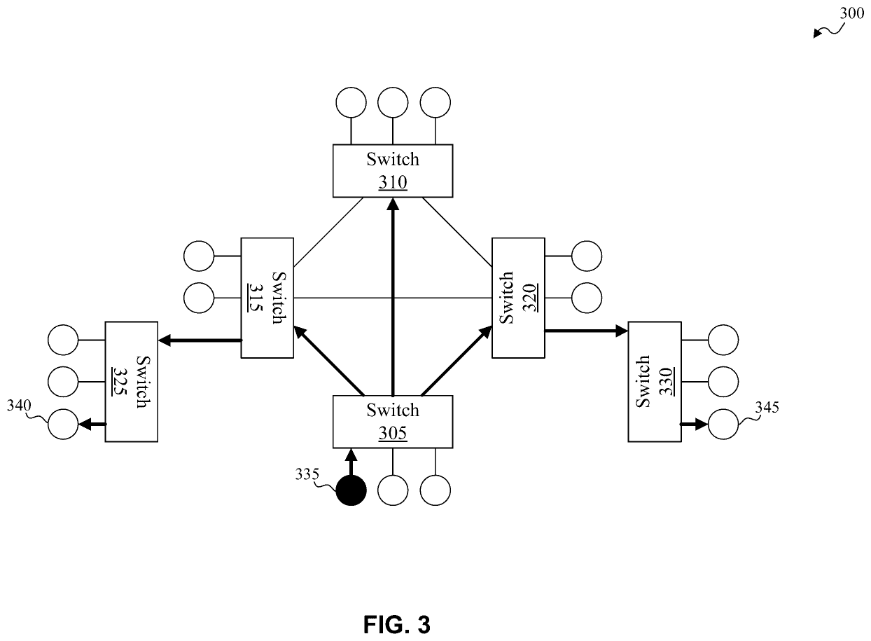

FIG. 3 illustrates an example system 300 in accordance with one or more implementations as described herein. System 300 may include one or more switches. In some cases, at least one switch of system 300 may be an example of machine 105 of FIG. 1 and/or FIG. 2. In some cases, at least one switch of system 300 may include at least one packet engine configured to perform one or more operations of the systems and methods described herein. As shown, the switches of system 300 may include one or more nodes. In some cases, a node of system 300 may include logic that includes any combination of hardware (e.g., at least one memory, at least one processor, at least one storage device), logical circuitry, firmware, and/or software. In some cases, a node may include a system on chip. In some examples, system 300 may represent a multicast group. The switches of system 300 may be part of a multicast group.

In the illustrated example, system 300 may include switch 305, switch 310, switch 315, switch 320, switch 325, and switch 330. As shown, switch 305 may include one or more nodes (e.g., source node 335), switch 325 may include one or more nodes (e.g., node 340), and switch 330 may include one or more nodes (e.g., node 345). In the illustrated example, source node 335 may generate a source packet (e.g., inject a source packet in system 300). In some cases, switch 305 may be referred to as a source switch based on source node 335 generating the source packet (e.g., original source packet). In some cases, switch 310, switch 315, switch 320, switch 325, and/or switch 330 may be referred to as remote switches based on receiving an encapsulated copy of the source packet directly and/or indirectly from a source switch (e.g., switch 305). In some cases, nodes of a remote switch (e.g., node 340, node 345) may be referred to as remote nodes.

In some examples, switch 305 may generate multiple encapsulated packets (e.g., encapsulate the source packet generated by source node 335). For example, switch 305 may include routing information in the encapsulated packets. The routing information may include switch 310, switch 315, switch 320, switch 325, node 340 of switch 325, switch 330, and node 345 of switch 330.

In the illustrated example, switch 305 may transmit a first copy of the encapsulated packet to switch 310, a second copy of the encapsulated packet to switch 315, and a third copy of the encapsulated packet to switch 320. In some cases, switch 315 may generate and transmit a fourth copy of the encapsulated packet to switch 325, and switch 320 may generate and transmit a fifth copy of the encapsulated packet to switch 330. As shown, switch 325 may de-encapsulate the fourth copy of the encapsulated packet and transmit a copy of the source packet of the de-encapsulated fourth copy of the encapsulated packet to node 340. In the illustrated example, switch 330 may de-encapsulate the fifth copy of the encapsulated packet and transmit a copy of the source packet of the de-encapsulated fifth copy of the encapsulated packet to node 345.

The systems and methods avoid sending packets to unintended recipients. For example, node 340 is an intended recipient, and so node 340 receives a copy of the source packet, while another node of switch 325 does not receive a copy of the source packet. Based on the systems and methods, a first switch receives a copy of the encapsulated packet from the second switch (e.g., based on one-to-one communication of the encapsulated packet). For example, switch 310 receives a copy of the encapsulated packet from switch 305. And while switch 310 includes a connection to switch 315 and switch 320, switch 310 does not receive a copy of the encapsulated packet from switch 315 or switch 320. Accordingly, the systems and methods reduce the number of packets generated for multicast operations. Instead of the potential squared term explosion of packets created, the minimum number of packets for a given multicast are produced. Also, the described techniques minimize traffic (e.g., avoid flooding) by preventing packets from being blindly duplicated and forwarded. Also, the described techniques relieve the sender from knowing every intended destination and generating a unique frame addressed to each destination. Furthermore, the described techniques prevent a multicast packet from degenerating into a series of unicast targeted to the intended endpoints specified in the associated multicast group at the first switch.

The systems and methods enable routing around failed links to distribute multicast packets (e.g., based on routing information in encapsulated packets and route tables providing alternative paths). For example, if a packet engine of switch 305 were to determine a link between switch 305 and switch 310 failed, switch 305 may route a copy of the encapsulated packet to switch 320 and switch 320 may transmit the copy of the encapsulated packet to switch 310.

In some examples, a switch that receives a copy of the encapsulated packet may send a completion message to the switch that sent the encapsulated packet, where the completion message indicates the receiving switch successfully received the encapsulated packet, and that each node intended to receive the source packet has successfully received a copy of the source packet. In some cases, a switch may resend a copy of the source packet to a node that does not respond with a completion message within a given time period (e.g., timeout period, expiration). In some cases, the switch may retry a given number of times (e.g., 2 times, 3 times, 4 times, etc.) before sending a failure message to the switch that sent the encapsulated packet.

In some examples, node 340 may transmit a completion message to switch 325, indicating receipt of a copy of the source packet. In some cases, node 345 may transmit a completion message to switch 330, indicating receipt of a copy of the source packet. In some implementations, switch 325 may transmit a completion message to switch 315, indicating receipt of the fourth copy of the encapsulated packet. In some examples, switch 330 may transmit a completion message to switch 320, indicating receipt of the fifth copy of the encapsulated packet.

In some implementations, switch 310 may transmit a completion message to switch 305 indicating receipt of the first copy of the encapsulated packet, switch 315 may transmit a completion message to switch 305 indicating receipt of the second copy of the encapsulated packet, and/or switch 320 may transmit a completion message to switch 305 indicating receipt of the third copy of the encapsulated packet.

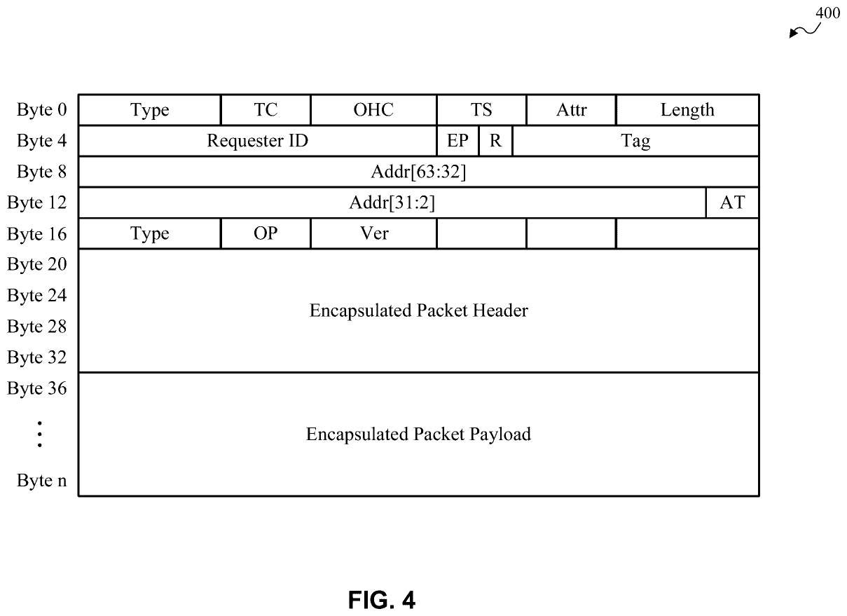

FIG. 4 illustrates an example packet 400 in accordance with one or more implementations as described herein. In the illustrated example, packet 400 may depict the format of a packet (e.g., multicast packet, multicast TLP). In some cases, the format of packet 400 may be based on PCIe.

In the illustrated example, packet 400 may include a type field that may indicate a type of TLP, Traffic Class (TC) field that may indicate a priority of a transaction as it travels through a PCIe link, an Orthogonal Header Content (OHC) field, a trailer size (TS), an attribute (Attr), a length of data payload field, the Requester ID field, an error forwarding (EP) bit field, a reserved (R) field, the tag field, and one or more encapsulated payload descriptors (e.g., encapsulated payload type field, encapsulated payload operation bit, encapsulated payload version, etc.).

In some cases, packet 400 may represent an encapsulated packet (e.g., encapsulated multicast TLP). As shown, packet 400 may include an encapsulated packet header (e.g., encapsulated original multicast TLP header) and an encapsulated packet header (e.g., encapsulated original multicast TLP payload).

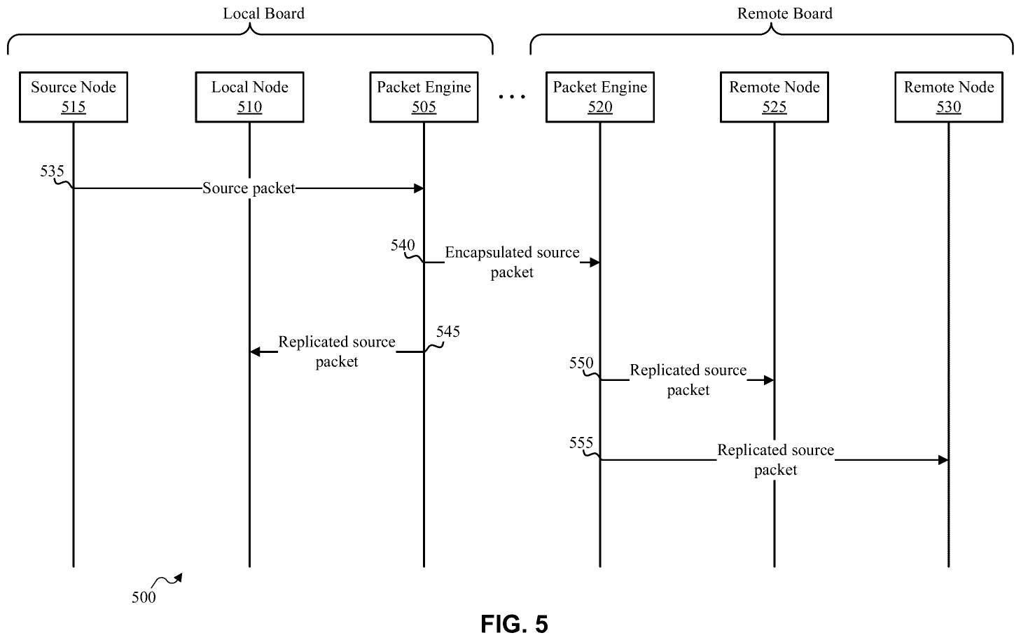

FIG. 5 illustrates an example diagram 500 (e.g., a ladder diagram) in accordance with one or more implementations as described herein. In the illustrated example, diagram 500 depicts packet engine 505, local node 510, and source node 515 of a local board (e.g., a board that is local to the origination of the source packet). As shown, diagram 500 includes packet engine 520, remote node 525, and remote node 530 of a remote board (e.g., a board that is remote to the origination of the source packet). A board (e.g., printed circuit board) may include multiple switches and/or multiple compute nodes. In some cases, a board may be assembled into a data-center rack and multiple such racks may form a supercomputer system. In some cases, a switch may include multiple packet engine entities. Although diagram 500 depicts interaction between a local board and a remote board, it is understood that the depicted operations may occur between the local board and multiple remote boards including the depicted remote board (e.g., N remote boards where N is a positive integer such as 8, 16, 32, 64, 100, 128, etc.). Packet engine 505 may be part of a local switch (e.g., of the local board), while packet engine 520 may be part of a remote switch (e.g., of the remote board). In some cases, packet engine 505 may include or represent multiple packet engines of the local board, and/or packet engine 520 may include or represent multiple packet engines of the remote board. Packet engine 505 and/or packet engine 520 may be examples of packet engine 140 of FIG. 1 and/or packet engine 230 of FIG. 2.

At 535, source node 515 may provide a source packet to packet engine 505. In some cases, the source packet may be a multicast packet (e.g., multicast TLP). In some cases, the source packet of diagram 500 may be a posted packet. With posted packets, no response may be generated or expected (e.g., fire-and-forget packets). With non-posted packets, a response or completion message may be sent in the reverse direction from the receiver to the sender to indicate the packet is received.

At 540, packet engine 505 may transmit an encapsulated packet routed to packet engine 520 of a remote switch. For example, packet engine 505 may encapsulate the source packet from source node 515 and transmit a copy of the encapsulated packet to packet engine 520. In some examples, a local switch may transmit a copy of the encapsulated packet to multiple remote switches (e.g., a respective copy of the encapsulated packet to a respective remote switch). For example, packet engine 505 may transmit a second copy of the encapsulated packet to a packet engine of a second remote switch different from packet engine 520.

At 545, packet engine 505 may transmit a copy of the source packet to local node 510. In some cases, packet engine 505 may transmit a copy of the source packet to multiple local nodes (e.g., a respective copy of the source packet to a respective local node), other than the node that generated the source packet (e.g., source node 515).

At 550, packet engine 520 may transmit a copy of the source packet to remote node 525. In some examples, packet engine 520 may obtain a copy of the source packet based on the encapsulated packet that packet engine 520 receives from packet engine 505. Packet engine 520 may de-encapsulate the encapsulated packet to obtain the source packet included in the encapsulated packet. Packet engine 520 may then transmit the copy of the source packet to remote node 525.

At 555, packet engine 520 may transmit a second copy of the source packet to remote node 530. In some cases, remote node 525 and remote node 530 may be nodes local to packet engine 520 (e.g., nodes associated with and/or communicatively linked to packet engine 520). In some cases, packet engine 520 may transmit a copy of the source packet to multiple local nodes (e.g., a respective copy of the source packet to a respective local node).

In some examples, a packet engine of a switch (e.g., a switch depicted in diagram 500) may generate and/or maintain a hash or similar mechanism to detect a reflected packet or rogue packet from constantly circulating a loop (a loop of system 300). The systems and methods may implement a hash for posted packets and/or non-posted packets. In some cases, a timeout may be configured to clear the hash. In some examples, a packet engine of a given switch may store and/or maintain the hash of a packet, a source ID of the packet, and/or other fields to prevent aliasing of the hash, where aliasing could result in incorrectly discarding a packet. In some cases, each packet transaction from a participant (e.g., switch, node of a switch) may include a unique tag. For example, a first packet may be associated a first tag and a second packet may be associated with a second tag different from the first tag. A second packet sent relatively close in time to a first packet is unlikely to alias with the first packet. Accordingly, the systems and methods avoid the overhead of other systems (e.g., systems based on time to live (TTL) mechanisms that count hops or amount of time a packet exists within a network before discarding the packet.

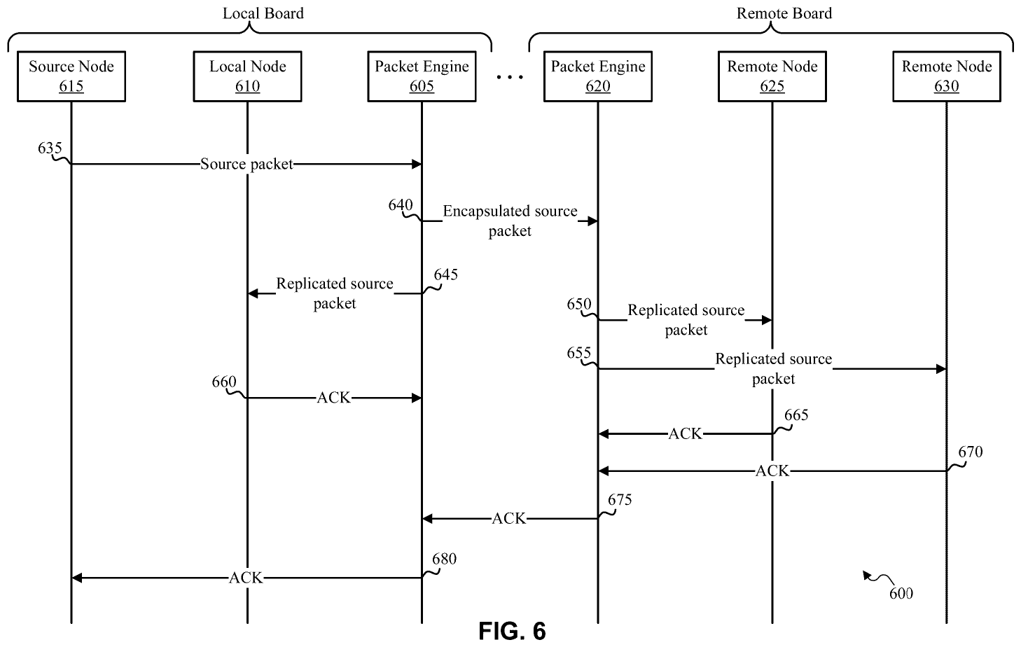

FIG. 6 illustrates an example diagram 600 (e.g., a ladder diagram) in accordance with one or more implementations as described herein. In the illustrated example, diagram 600 depicts packet engine 605, local node 610, and source node 615 of a local board. As shown, diagram 600 depicts packet engine 620, remote node 625, and remote node 630 of a remote board. Although diagram 600 depicts interaction between a local board and a remote board, it is understood that the depicted operations may occur between the local board and multiple remote boards including the depicted remote board (e.g., N remote boards). Packet engine 605 may be part of a local switch (e.g., of the local board), while packet engine 520 may be part of a remote switch (e.g., of the remote board). In some cases, packet engine 605 may include or represent multiple packet engines of the local board, and/or packet engine 620 may include or represent multiple packet engines of the remote board. Packet engine 505 and/or packet engine 520 may be examples of packet engine 140 of FIG. 1, packet engine 230 of FIG. 2, packet engine 505 of FIG. 5, and/or packet engine 520 of FIG. 5.

At 635, source node 615 may provide a source packet to packet engine 605. In some cases, the source packet may be a multicast packet (e.g., multicast TLP). In some cases, the source packet of diagram 600 may be a non-posted packet. With non-posted packets, a response or completion message may be sent in the reverse direction from the receiver to the sender to indicate the packet is received and/or indicate an error in packet reception.

At 640, packet engine 605 of a local switch may transmit an encapsulated packet to packet engine 620 of a remote switch. For example, packet engine 605 may encapsulate the source packet from source node 615 and transmit a copy of the encapsulated packet to packet engine 620. In some examples, local switch may transmit a copy of the encapsulated packet to multiple remote switches (e.g., a respective copy of the encapsulated packet to a respective remote switch). For example, packet engine 605 may transmit a second copy of the encapsulated packet to a second remote switch different from packet engine 620.

At 645, packet engine 605 may transmit a copy of the source packet to local node 610. In some cases, packet engine 605 may transmit a copy of the source packet to multiple local nodes (e.g., a respective copy of the source packet to a respective local node), other than the node that generated the source packet (e.g., source node 615).

At 650, packet engine 620 may transmit a copy of the source packet to remote node 625. In some examples, packet engine 620 may obtain a copy of the source packet based on the encapsulated packet that packet engine 620 receives from packet engine 605. Packet engine 620 may de-encapsulate the encapsulated packet to obtain the source packet included in the encapsulated packet. Packet engine 620 may then transmit the copy of the source packet to remote node 625.

At 655, packet engine 620 may transmit a second copy of the source packet to remote node 630. In some cases, remote node 625 and remote node 630 may be nodes local to packet engine 620 (e.g., nodes associated with and/or communicatively linked to packet engine 620). In some cases, packet engine 620 may transmit a copy of the source packet to multiple local nodes (e.g., a respective copy of the source packet to a respective local node).

At 660, local node 610 may transmit a completion message (e.g., acknowledgement) to packet engine 605. The completion message may indicate that the copy of the source packet was successfully received by local node 610.

At 665, remote node 625 may transmit a completion message (e.g., acknowledgement) to packet engine 620. The completion message may indicate that the copy of the source packet was successfully received by remote node 625.

At 670, remote node 630 may transmit a completion message (e.g., acknowledgement) to packet engine 620. The completion message may indicate that the copy of the source packet was successfully received by remote node 630.

At 675, packet engine 620 may transmit a completion message (e.g., acknowledgement) to packet engine 605. The completion message may indicate that the copy of the encapsulated packet was successfully received by local node 610. Packet engine 620 may transmit the completion message based on packet engine 620 receiving the completion message from remote node 625 and receiving the completion message from remote node 630. In some cases, the completion message from packet engine 620 may indicate that remote node 625 and remote node 630 received respective copies of the source packet.

At 680, packet engine 605 may transmit a completion message (e.g., acknowledgement) to source node 615. The completion message may indicate that copies of the source packet were successfully distributed by packet engine 605. In some cases, the completion message may indicate which local nodes successfully received a copy of the source packet, which local nodes failed to receive a copy of the source packet, which remote switches successfully received a copy of the encapsulated packet, which remote switches failed to receive a copy of the encapsulated packet, which remote nodes successfully received a copy of the source packet, and/or which remote nodes failed to receive a copy of the source packet.

The systems and methods may include non-posted multicast messages, providing guaranteed delivery of messages to intended participants in a multicast group. In some cases, a packet engine of a switch (e.g., packet engine of a source switch) may track the state of distributed messages and responses from participants. In some examples, the packet engine of a source switch that first receives a multicast packet (e.g., from a source node of the source switch) may track which packet engines the source switch sends a copy of the encapsulated packet as well as the source node (e.g., originating end point). In some cases, the packet engine of a remote switch may track which switch sent it the encapsulated packet. In some cases, the packet engine of the remote switch may track which remote nodes that the remote switch sends copies of the source packet.

Based on the systems and methods, the packet engine of a switch (e.g., each switch) may wait for a completion message (e.g., response TLP, acknowledgement) from each end point that receives a copy of the source packet (e.g., remote node 625, remote node 630). When no response is received, the packet engine may resend a copy of the source packet to the non-responsive end-point. In some cases, the packet engine may report an error. When retrying, a limited number of re-tries may be attempted to avoid system hangs. When the packet engine identifies a failure, the packet engine may log the nonresponsive node (e.g., for system recovery purposes).

Once a packet engine of a switch (e.g., other than the packet engine of the source switch) receives a response from all locally attached participants, the packet engine may act as a proxy and send a collective completion message to the packet engine in the source switch. For example, packet engine 620 may act as a proxy and send a collective completion message to packet engine 605. The packet engine of the source switch may wait for the responses from all participating packet engines reporting that non-local participants have responded, as well as responses from its locally attached participants. The packet engine of the source switch may then respond to the originating source node with a single completion message. The completion message may indicate packet delivery success messages and/or packet delivery failure messages.

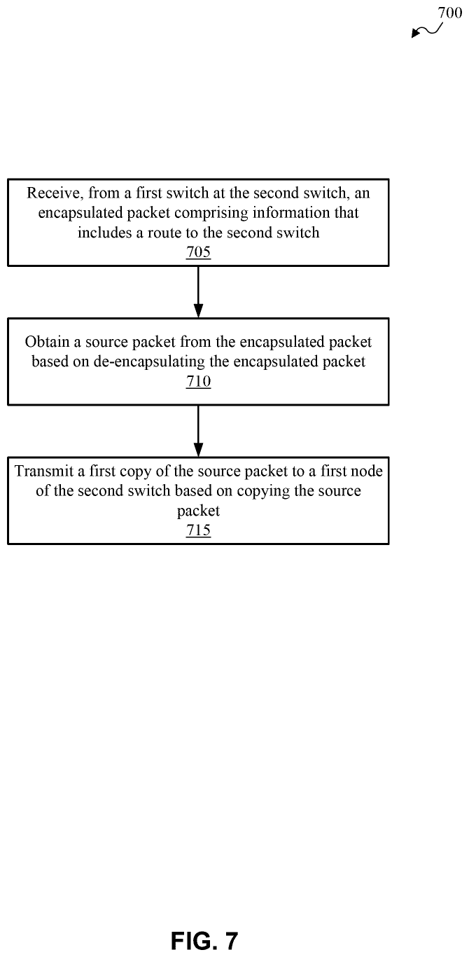

FIG. 7 depicts a flow diagram illustrating an example method 700 associated with the disclosed systems, in accordance with example implementations described herein. In some configurations, method 700 may be implemented by packet engine 140 of FIG. 1 and/or packet engine 230 of FIG. 2. In some configurations, method 700 may be implemented in conjunction with machine 105, components of machine 105, or any combination thereof. The depicted method 700 is just one implementation and one or more operations of method 700 may be rearranged, reordered, omitted, and/or otherwise modified such that other implementations are possible and contemplated.

At 705, method 700 may include receiving, from a first switch at a second switch, an encapsulated packet comprising information that includes a route to the second switch. For example, packet engine 140 may receive, from local switch at packet engine 520, an encapsulated packet comprising information (e.g., routing information) that includes a route to packet engine 520 and that indicates a first node of the second switch is included in a multicast operation.

At 710, method 700 may include obtaining a source packet from the encapsulated packet based on de-encapsulating the encapsulated packet. For example, packet engine 140 may obtain a source packet from the encapsulated packet based on de-encapsulating the encapsulated packet.

At 715, method 700 may include transmitting a first copy of the source packet to a first node of the second switch based on copying the source. For example, packet engine 140 may transmit a first copy of the source packet to remote node 525 based on generating one or more copies of the source packet and based on determining the information indicates the first node of the second switch is included in the multicast operation.

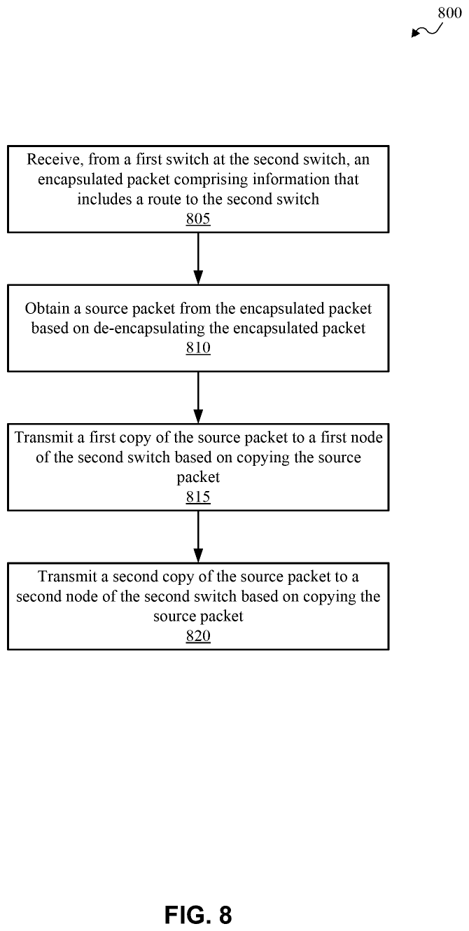

FIG. 8 depicts a flow diagram illustrating an example method 800 associated with the disclosed systems, in accordance with example implementations described herein. In some configurations, method 800 may be implemented by packet engine 140 of FIG. 1 and/or packet engine 230 of FIG. 2. In some configurations, method 800 may be implemented in conjunction with machine 105, components of machine 105, or any combination thereof. The depicted method 800 is just one implementation and one or more operations of method 800 may be rearranged, reordered, omitted, and/or otherwise modified such that other implementations are possible and contemplated.

At 805, method 800 may include receiving, from a first switch at a second switch, an encapsulated packet comprising information that includes a route to the second switch. For example, packet engine 140 may receive, from local switch at packet engine 520, an encapsulated packet comprising information (e.g., routing information) that includes a route to packet engine 520 and that indicates a first node of the second switch is included in a multicast operation.

At 810, method 800 may include obtaining a source packet from the encapsulated packet based on de-encapsulating the encapsulated packet. For example, packet engine 140 may obtain a source packet from the encapsulated packet based on de-encapsulating the encapsulated packet.

At 815, method 800 may include transmitting a first copy of the source packet to a first node of the second switch based on copying the source. For example, packet engine 140 may transmit a first copy of the source packet to remote node 525 based on generating one or more copies of the source packet and based on determining the information indicates the first node of the second switch is included in the multicast operation.

At 820, method 800 may include transmitting a second copy of the source packet to a second node of the second switch based on copying the source packet. For example, packet engine 140 may transmit a second copy of the source packet to remote node 530 based on generating the one or more copies of the source packet.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples described herein set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of a computer network, the method comprising:
receiving, from a first switch at a second switch, an encapsulated packet comprising information that includes a route to the second switch and indicates a first node of the second switch is included in a multicast operation; obtaining a source packet from the encapsulated packet based on de-encapsulating the encapsulated packet; and
transmitting a first copy of the source packet to the first node of the second switch based on copying the source packet and based on determining the information indicates the first node of the second switch is included in the multicast operation.

2. The method of claim 1, further comprising transmitting a second copy of the source packet to a second node of the second switch based on copying the source packet and based on determining the second node of the second switch is included in the multicast operation.

3. The method of claim 2, further comprising:
receiving, from the first node, a first node acknowledgement indicating the first node received the first copy of the source packet; and
receiving, from the second node, a second node acknowledgement indicating the first node received the first copy of the source packet.

4. The method of claim 2, further comprising transmitting, to the first switch, a switch acknowledgement indicating the second switch received the encapsulated packet.

5. The method of claim 4, wherein the switch acknowledgement indicates the first node of the second switch received the first copy of the source packet and indicates the second node of the second switch received the second copy of the source packet.

6. The method of claim 1, further comprising omitting transmission of a copy of the source packet to a third node of the second switch based on the information excluding the third node.

7. The method of claim 1, further comprising:
generating a hash based on receiving a second encapsulated packet;
comparing the hash to a group hash associated with a multicast group that includes the first switch and the second switch; and
dropping the second encapsulated packet based on the comparing indicating a match between the hash and the group hash.

8. The method of claim 1, wherein:
the encapsulated packet comprises the source packet that is encapsulated by the first switch, and
a header of the encapsulated packet includes the information for one or more switches, including the second switch.

9. The method of claim 1, wherein de-encapsulating the encapsulated packet includes removing the information from the encapsulated packet.

10. The method of claim 1, wherein:
the computer network comprises a high-performance computing (HPC) network protocol based on at least one of peripheral component interconnect express (PCIe), InfiniBand, Ethernet or Omni-Path, and
the source packet comprises a format based on the HPC network protocol.

11. A method of a computer network, the method comprising:
obtaining, at a first switch, a source packet from a source node of the first switch;
generating an encapsulated packet based on information that includes a route to a second switch and based on the information indicating a first node of the second switch are included in a multicast operation;
transmitting a first copy of the encapsulated packet to the second switch based on determining the information indicates the first node of the second switch are included in the multicast operation; and
receiving, from the second switch, a switch acknowledgement indicating the second switch received the encapsulated packet.

12. The method of claim 11, further comprising:
identifying a failed link to a third switch; and
routing a second copy of the encapsulated packet to the third switch over an alternative path based on network topology information of the computer network.

13. The method of claim 11, wherein generating the encapsulated packet comprises adding the information to a header of the encapsulated packet.

14. The method of claim 11, wherein the switch acknowledgement indicates the first node of the second switch received a first copy of the source packet and a second node of the second switch received a second copy of the source packet.

15. The method of claim 11, wherein:
the computer network comprises a high-performance computing (HPC) network protocol based on at least one of peripheral component interconnect express (PCIe), InfiniBand, Ethernet or Omni-Path, and
the source packet comprises a format based on the HPC network protocol.

16. A non-transitory computer-readable medium storing code that comprises instructions executable by a processor of a second switch to:
receive, from a first switch at the second switch, an encapsulated packet comprising information that includes a route to the second switch and indicates a first node of the second switch is included in a multicast operation;
obtain a source packet from the encapsulated packet based on de-encapsulating the encapsulated packet; and
transmit a first copy of the source packet to the first node of the second switch based on copying the source packet and based on determining the information indicates the first node of the second switch is included in the multicast operation.

17. The non-transitory computer-readable medium of claim 16, wherein the code includes further instructions executable by the processor to cause the second switch to transmit a second copy of the source packet to a second node of the second switch based on copying the source packet and based on determining the second node of the second switch is included in the multicast operation.

18. The non-transitory computer-readable medium of claim 17, wherein the code includes further instructions executable by the processor to cause the second switch to:
receive, from the first node, a first node acknowledgement indicating the first node received the first copy of the source packet; and
receive, from the second node, a second node acknowledgement indicating the first node received the first copy of the source packet.

19. The non-transitory computer-readable medium of claim 17, wherein the code includes further instructions executable by the processor to cause the second switch to transmit, to the first switch, a switch acknowledgement indicating the second switch received the encapsulated packet.

20. The non-transitory computer-readable medium of claim 19, wherein the switch acknowledgement indicates the first node of the second switch received the first copy of the source packet and indicates the second node of the second switch received the second copy of the source packet.
